(19) United States
(12) Patent Application Publication
(10) Pub. No.: US 2023/0258419 A1
(43) Pub. Date: Aug. 17, 2023

(54) LOW-COST ENGINEERED PARTICLES FOR THERMAL ENERGY TRANSFER OR STORAGE

(71) Applicant: Advanced Materials Scientia LLC, Bothell, WA (US)

(72) Inventors: Kyu Bum HAN, Bothell, WA (US); Eunjin JEON, Bothell, WA (US); Patrick DAVENPORT, Golden, CO (US); Zhiwen MA, Golden, CO (US)

(21) Appl. No.: 18/168,613

(22) Filed: Feb. 14, 2023

Related U.S. Application Data
(60) Provisional application No. 63/309,702, filed on Feb. 14, 2022.

(51) Int. Cl. F28F 21/04; F28F 21/08

(52) U.S. Cl. CPC F28F 21/04; F28F 21/089; F28F 2255/18

(57) ABSTRACT

The present disclosure relates to particles for heat transfer and/or heat storage. Particularly, by coating metal oxides on the silica surface, the solar absorptivity becomes higher than the conventional ceramic proppant. The particles the present disclosure are durable at ultra-high temperatures while their solar absorptivity is recoverable multiple time as heat transfer and/or heat storage. The present disclosure can be applied to concentrating solar power industry. The present disclosure significantly reduces the Levelized cost of the energy due to low-cost product and high solar absorptivity.

### CROSS-REFERENCE TO RELATED APPLICATION

The benefit under 35 USC § 119 of U.S. Provisional Patent Application 63/309,702 filed Feb. 14, 2022 in the names of Kyu Bum HAN, et al. for “LOW-COST ENGINEERED PARTICLES FOR THERMAL ENERGY TRANSFER OR STORAGE” is hereby claimed. The disclosure of U.S. Provisional Patent Application 63/309,702 is hereby incorporated herein by reference, in its entirety, for all purposes.

### TECHNICAL FIELD

The present disclosure relates to novel engineered particles for thermal energy transfer or storage. More particularly, the invention relates to the particles coated with metal oxides on the silica surface. The particles of the present disclosure highly absorb solar radiation and are exceedingly durable at ultra-high temperatures. At the same time, the particles are low-cost, and the solar absorptivity of the spent particles is recoverable multiple times

### BACKGROUND ART

The third generation concentrating solar power (Gen3 CSP) is the particle-based system. The solid particle system is preferred as increasing the operation temperature, so the system provides more energy efficiency. The desirable operation temperature for Gen3 CPS is equal or above 1,000° C. (M. Mehos et al., “Concentrating Solar Power Gen 3 Demonstration Roadmap,” National Renewable Energy Laboratory, Golden, Colo., 2017).

The present disclosure is completed after confirming that it can be usefully used for concentrating solar power generation. A silica coated with metal oxides demonstrates higher solar absorption than current ceramic proppants. The particles of the present disclosure are durable at an ultra-high temperature. The spent particles reduce the solar absorptivity after exposing at 1,000° C. The particles the present disclosure recover the solar absorptivity multiple times. Furthermore, the cost of the particles is remarkably lower than the proppant.

### SUMMARY OF THE INVENTION

The objective of the present disclosure is to develop the low-cost particles, which have high solar absorptivity, durability at an ultra-high temperature, and the ability to be recovered multiple times.

In order to achieve the objective, an aspect of the present disclosure provides a particle for heat transfer or heat storage comprising: (a) a core comprising silica; and (b) a metal oxide coating layer coated on the core.

Another aspect of the present disclosure provides a method of producing the particle for heat transfer or heat storage of claim 1, comprising: (a) mixing silica, water, and metal oxide powder to obtain a slurry; (b) milling the slurry, and (c) sintering the milled slurry.

### Effect of Invention

Concentrating solar power (CSP) with thermal energy storage (TES) system technology is important to reduce the levelized cost of energy. The particle-based CSP is the third generation, called Gen3 CSP. The particles become the thermal energy receiver, transporter, and storage media. The particles used in Gen3 CSP demand high solar absorptivity, high durability, and multiple recoverability at ultra-high temperatures such as 1000° C. or greater. Growing awareness of environmental pollution by existing power plants and growing concerns about global warming are accelerating the growth of the CSP market. Even if the high capital cost for the deployment of the present disclosure hinders the market, the CSP technology using the particles according to the present disclosure is expected to reduce the Levelized cost of energy (LCOE) to 0.059$/kW-hr, thereby revitalizing the CSP market.

The particles for heat transfer and/or heat storage in Gen3 CSP according to the present disclosure meet the technical demand by having high solar absorption, multiple recoverability, and high durability even at an ultra-high temperature of 1,000° C.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram of sphericity and roundness classification.

FIG. 2A to FIG. 2C are images of silica particles ball milled at 0 RPM, 134 RPM and 268 RPM for 1 hour.

FIG. 3A to FIG. 3C are the measured circle-equivalent (CE) diameter, sphericity, roundness of the silica particles ball milled at 0 RPM, 134 RPM and 268 RPM for 1 hour.

FIG. 4 is a schematic diagram of an apparatus for manufacturing iron oxide-coated silica for thermal energy storage according to an embodiment of the present disclosure in a reduced atmosphere.

FIG. 5 is an image of silica coated with iron oxide for thermal energy storage according to an embodiment of the present disclosure.

FIG. 6 is particle size distribution of reduced hematite coated silica sand in forming gas condition at 400° C. for 3 hours according to the present invention. The average size of particle was 284 microns. The 90th percentile of the size distribution was 486 microns, and the 10th percentile was 147 microns.

FIG. 7 is the measured absorption spectrum from 280 nm to 2500 nm of (1) black body standard and (2) iron oxide coated silica.

FIG. 8 shows analysis of solar absorptivity reproducibility. AMS repeated the engineered particle fabrication by 22 times for reproducibility analysis.

FIG. 9 is the calculated sunlight-absorbed percent from the measured absorption 280 nm to 2500 nm. The iron oxide coated silica particles are subjected to the durability test at 1,000° C. in air for 2 days. The spent particles are reduced for 0 hour, 3 hours, and 14 hours, and 24 hours.

FIG. 10 is the calculated sunlight-absorbed percent from the measured absorption from 280 nm to 2500 nm where Do is initial starting, D₁ is oxidized in air at 1,000° C. for 48 hours, R₁ is reduced D₁ particles for 14 hours, D₂ is the oxidized in air at 1,000° C. for 48 hours, and R₂ is reduced D₂ particles for 14 hours. During every recovery reaction, the particle color became black (images inside FIG. 10). The particles demonstrated the recovery of the absorptance and thermal emittance multiple times.

FIG. 11A shows X-ray diffraction of iron oxides in multiple cycled particles according to an example of the present invention.

FIG. 11B shows the XRD raw data by refined to quantify the iron oxides in weight percent according to an example of the present invention.

FIG. 12A shows specific heat of the particle from 250° C. to 1050° C. according to an example of the present invention.

FIG. 12B shows the thermal conductivity of the particle according to an example of the present invention.

### DETAILED DESCRIPTION OF THE INVENTION

Unless defined otherwise, all technical and scientific terms used herein have the same meanings as appreciated by those skilled in the field to which the present disclosure pertains. In general, the nomenclature used herein is well-known in the art and is ordinarily used.

The particles of the present disclosure are heat transferable and/or heat storage media. The particles are structured with low-cost materials. The particles have higher solar absorptivity than conventional ceramic proppant. The particles are stable at 1,000° C. The spent particles' absorptivity is recovered multiple times by reducing them.

The particle for heat transfer or heat storage according to the present disclosure comprises the following components: (a) a core comprising silica, and (b) a metal oxide coating layer coated on the surface of the core. The particles for heat transfer or heat storage according to the present disclosure are silica-based materials, which are economical materials and have high heat storage properties.

The cost of silica is approximately 30 times lower than ceramic proppant. Additionally, the silica allows long-term heat storage at ultra-high temperatures (about 1000° C. and above). The absorbed energy through the coated surface is stored in the silica. This unique property of silica makes it more suitable for energy storage on large scales. However, low solar absorptivity of silicas is not suitable for Gen3 CSP.

The solar absorptivity is significant for thermal energy transfer vehicles and storage media. The solar absorptivity is highly determined by the surface color of particles. For example, the silica, which has white color, can absorb only 30% of sunlight. The color of the surface of the media surface determines the amount of solar radiation absorption because it has to absorb solar energy in a short time. White color generally absorbs from 25% to 40% of solar radiation on the surface, and the absorptivity of black color is 90% or greater while red color is about 70%.

When metal oxides such as iron oxides (Fe₃O₄, FeO, and Fe⁰) are coated on silica, the iron oxides can improve solar absorptivity because the black color of the iron oxides enables them to highly absorb the concentrated sunlight. Iron (III) oxide (Fe₂O₃), which shows red color, is not suitable to obtain high solar absorptivity. In the present disclosure, the silica is coated with iron (III) oxide (Fe₂O₃) because iron (III) oxide is more economical than other iron oxides. The coated silica with iron (III) oxide is subsequently reduced to other iron oxides (Fe₃O₄, FeO, and Fe⁰). The iron (III) oxide-coated silica optically shows the red or brown color. The coated silica assumes a black color after reduction reaction in gas at elevated temperatures. As a result, the coated silica becomes a suitable thermal energy receiver and storage medium. The particles of the present disclosure show 90% of solar absorptivity. The absorption of solar radiation is increased by coating the iron oxides on the silica surface.

In the present disclosure, the silica can be silica sand.

In the present disclosure, the metal oxides can be at least one selected from the group consisting of hematite (Fe₂O₃), magnetite (Fe₃O₄), ferrous oxide (FeO) and zero-valent iron (Fe⁰), but are not limited thereto. The content of the metal oxide is 5 to 10 parts by weight based on 100 parts by weight of the silica, preferably 7 to 9 parts by weight. When the content of the metal oxide is within the above range, there is an effect of increasing the solar light absorption to 90% or more.

In the present disclosure, the size of the particles for thermal energy transfer and/or storage can be 100 μm to 800 μm, preferably 200 μm to 400 μm. The smaller the particle size, the higher the heat transfer and heating efficiency to the heat exchanger, so it is preferable. In the present disclosure, when the size of the particles is less than 100 μm, there is a problem of aggregation at high temperatures (1,000° C. or higher), and when it exceeds 800 μm, there is a problem of light scattering.

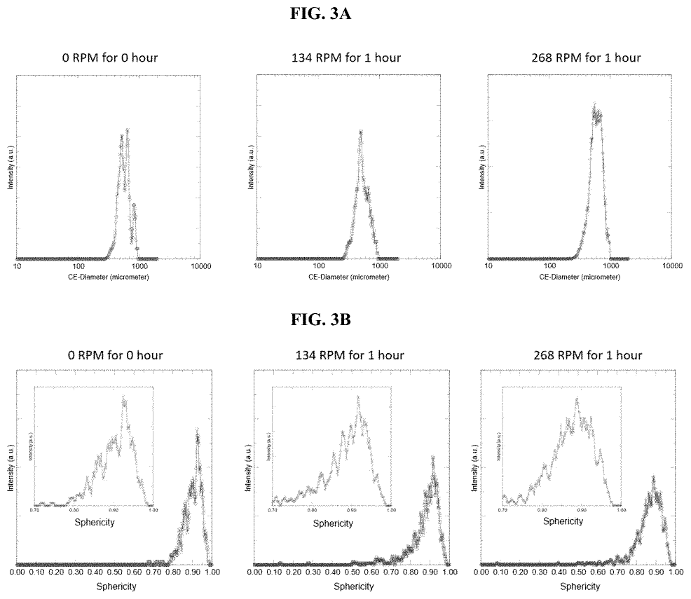

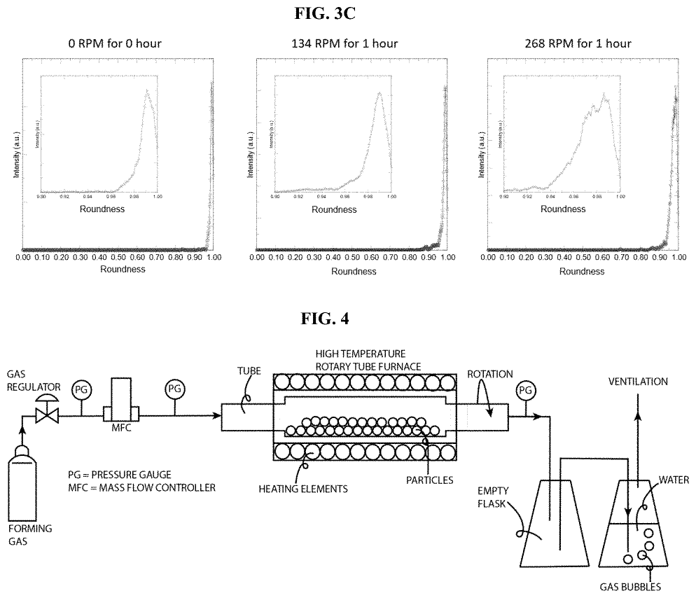

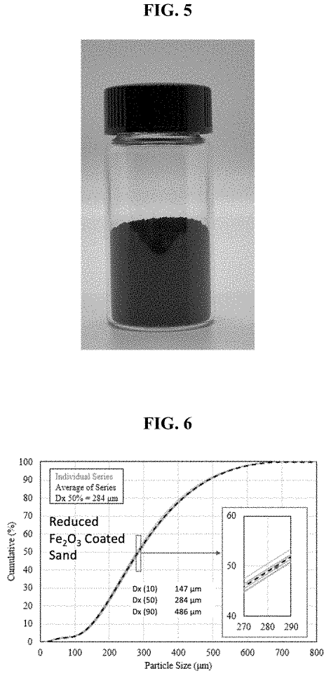

In the present disclosure, the roundness and sphericity of the particles can be 0.8 or more and 0.8 or more, respectively. As a heat transfer fluid, its high sphericity and roundness prevent interparticle collisions and erosion damage in CSP systems. As a heat storage medium, its high sphericity and roundness allow for tight packing of particles, creating high energy densities in heat storage systems (V. Picandet, S. Amziane and F. Collet Eds. Dordrecht: Springer Netherlands, 2017, pp. 111-124). Roundness and sphericity are represented by numbers and images (see FIG. 3) (W. C. Krumbein and L. L. Sloss, Stratigraphy and sedimentation. San Francisco: W.H. Freeman (in English), 1956). We aim for particle sphericity and roundness of 0.9 to minimize particle loss and collisions for the CSP component (A. Calderón et al., Energy Storage, vol. 1, no. 4, p. e63, 2019).

In another aspect, the present disclosure provides a method of producing the particle for heat transfer or heat storage of claim 1, comprising: (a) mixing silica, water, and metal oxide powder to obtain a slurry; (b) milling the slurry, and (c) sintering the milled slurry.

In the present disclosure, the milling may be performed at a temperature of 17° C. to 30° C. and at a speed of 40 rpm to 100 rpm for 1 to 3 days.

In the present disclosure, the sintering may be performed at 300° C.-900° C. The sintering is performed under gas atmosphere of hydrogen gas balancing argon gas or nitrogen gas.

In the present disclosure, the drying may be performed at room temperature for 30 minutes to 7 hours before sintering.

Hereinafter, although preferred embodiments will be described for better understanding of the present disclosure, it will be obvious to those skilled in the art that these embodiments are provided only for illustration of the present disclosure, a variety of modifications and alterations are possible without departing from the ideas and scope of the present disclosure and these modifications and alterations fall within the scope of claims of the present disclosure.

### EXAMPLE

### Example 1: Preparation of Iron Oxide-Coated Silica Heat Transfer Particles

Silica sand coated with magnetite (Fe₃O₄), ferrous oxide (FeO), and/or zero-valent iron (Fe⁰) was manufactured for high solar absorption. Silica sand, water, and hematite (Fe₂O₃) powder were mixed at room temperature. The hematite is selected because the material cost of hematite is about more than 40% lower than magnetite, ferrous oxide, and zero-valent iron. 9 wt. % of hematite is added to silica sand, and then water is added to the mixture resulting in a slurry. The amount of water is about twice of silica sand in weight. The slurry is milled at 60 rpm and room temperature for 3 days without media. During the milling process, the slurry is naturally dried at room temperature and became powder. The dried particles are sintered at 300° C.-900° C. (FIG. 4). The gas is used to create a reducing atmosphere. The gas includes hydrogen gas (H₂, 5%) balanced with argon or nitrogen. The gas flow rate is about 200 sccm. The sintering time is between 30 minutes and 7 hours. The finally produced silica sand coated with iron oxide for thermal energy storage is shown in FIG. 5.

### Example 2: Particle Size and Morphology

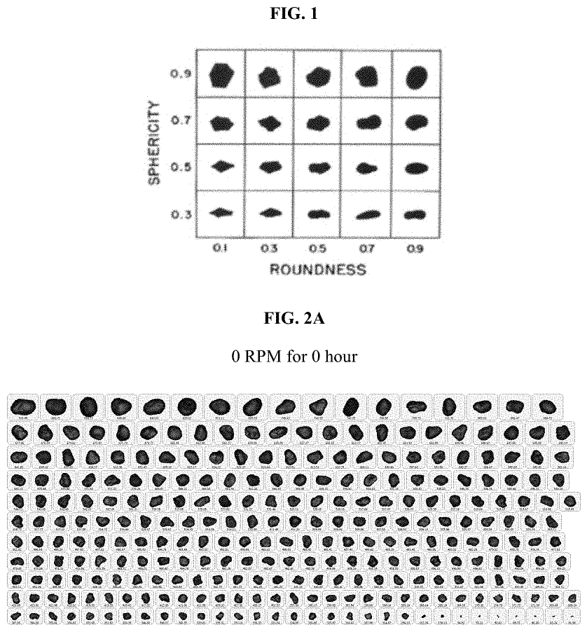

The roundness and sphericity of the particles are important for heat transfer and storage. As a heat transfer fluid, its high sphericity and roundness prevent interparticle collisions and erosion damage in concentrating solar power (CSP) systems. As a heat storage medium, its high sphericity and roundness allow for tight packing of particles, creating high energy densities in heat storage systems (V. Picandet, S. Amziane and F. Collet Eds. Dordrecht: Springer Netherlands, 2017, pp. 111). Roundness and sphericity are represented by numbers and images (FIG. 1) (W. C. Krumbein and L. L. Sloss, Stratigraphy and sedimentation. San Francisco: W.H. Freeman, 1956). We aim for particle sphericity and roundness of 0.9 to minimize particle loss and collusion for the CSP component (A. Calderón et al., Energy Storage, vol. 1, no. 4, p. e63, 2019).

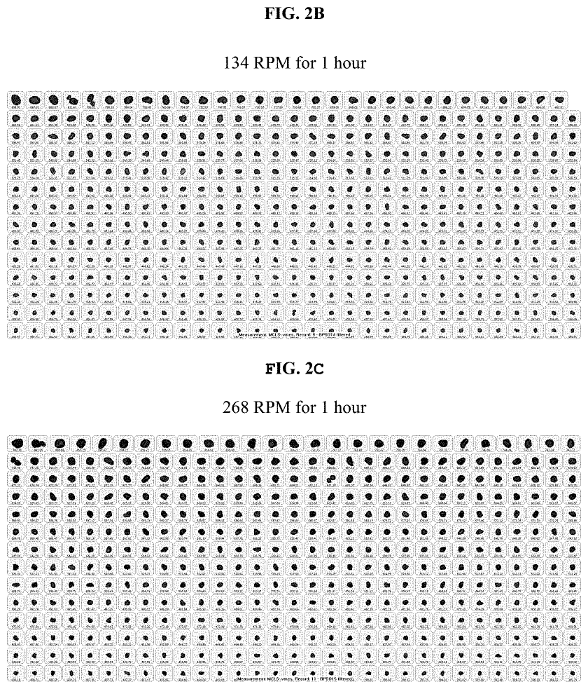

The diverse morphologies of particles are imaged by static images and the particle sizes are measured by using the same manner (FIG. 2). The silica particles are ball milled at 134 RPM and 268 RPM for 1 hour to improve the sphericity and roundness.

The sphericity and roundness of the particles are determined by static image analysis. sphericity (or High Sensitivity Circularity) and Roundness are obtained by Equation 1 and Equation 2 below (Malvern (2008). Morphologi G3 User Manual. M. I. Ltd. Worcestershire, UK); Convexity is a measurement of the surface roughness of a particle. The results are shown in FIG. 3.

$$Sphericity = \frac{4 \cdot π \cdot ParticleArea}{{Perimeter}^{2}} \qquad Equation 1$$

$$Roundness = \frac{ParticleArea}{ConvexHullArea} \qquad Equation 2$$

Particle size and morphology of the particles are improved by ball milling when the rotation speed is 134 rpm for 1 hour. The particle size and roundness become narrower while the sphericity remains constant. However, the particles are ball milled at 268 RPM for 1 hour, the size and roundness show a broader distribution than the milled particles at 134 RPM. The milled particles at 134 RPM for 1 hour show sphericity is 0.90 and roundness is 0.95 while the particle size is reduced from 520 μm to 450 μm

### Example 3: Comparison of Iron Oxide Coated Silica Heat Transfer Particles and Conventional Heat Transfer Particles

Table 1 shows the comparison between the materials currently used in the particle receiver system and the particles of the present disclosure.

TABLE 1
Comparison table of currently released products and materials
of the present disclosure (M. Mehos et al., National Renewable
Energy Laboratory, Golden, CO, 2017; Ma, M. Mehos et al.,
Energy Procedia, vol. 69, pp. 1349-1359, 2015).

| | | Solar | |
|---|---|---|---|
| | Low Cost | Absorptivity | Durability |
| Products | (<1 $/kg) | (>0.9) | (>700° C.) |
| Coal Ash | ◯ | X | ◯ |
| Silica | ◯ | X | ◯ |
| Silicon Carbide | X | ◯ | ◯ |
| Graphite | X | ◯ | X |
| Alumina | X | X | ◯ |
| Proppant | X | ◯ | ◯ |
| Present disclosure | ◯ | ◯ | ◯ |

Silica, which is an inexpensive particle compared to ceramic proppant, is preferable only as heat storage media but is not suitable as a direct heat transfer medium. Because silica has a low solar absorptivity, the silica is unable to transfer sufficient energy. To solve the problem, the present disclosure generates particles by coating silica with magnetite (Fe₃O₄), ferrous oxide (FeO), and/or zero-valent iron (Fe⁰). This material design results in a high solar absorptivity and inexpensive material. The particles of the present disclosure reduce Levelized cost of electricity (LCOE) significantly.

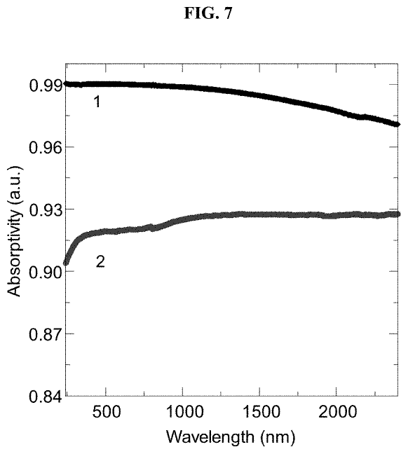

The particles of the present disclosure demonstrate high absorptivity in a full range of wavelength from 280 nm to 2500 nm (FIG. 7). The particles consistently absorb the entire spectrum. The calculated sunlight-absorbed fraction (or absorber efficiency (ii)) is 0.92. The equation of absorber efficiency (ii) (M. Mehos et al., National Renewable Energy Laboratory, Golden, Colo., 2017; Z. Ma et al., Energy Procedia, vol. 69, pp. 1349-1359, 2015) is described in Equation 3.

$$η = \frac{α \cdot Q - ε \cdot σ \cdot ( {T}^{4} )}{Q} \qquad Equation 3$$

where α is absorptivity, c is thermal emissivity, p is bulk density (g/cm³), and T is set up to 700° C. (973K), Q is the irradiance in the receiver (6×10⁵ W/m²), and a is Stefan-Boltzmann constant (5.67×10⁻⁸ w/m²K⁴). Other particles currently used in Gen3 CSP are summarized in Table 2.

TABLE 2
Summary of properties of particles and materials
utilized in the present disclosure.

| Materials | Price ($/kg) | η | References |
|---|---|---|---|
| Coal Ash | 0.01 | 0.43 | Y. Qin et al./M. Shimogori et |
| | | | al. |
| Silica | 0.03-0.04 | 0.35 | A. Palacios et al. |
| Hematite | 0.20 | 0.81 | A. Palacios et al. |
| Magnetite | 0.5 | 0.87 | V. Strapolova et al. |
| Silicon Carbide | 0.50-0.70 | 0.83 | A. Palacios et al. |
| Graphite | >0.5 | 0.76 | Engineering_ToolBox |
| Alumina | >1 | 0.11 | J. Henninger |
| Ceramic Proppant | 1-2 | 0.83 | N. Siegel et al. |
| Particle (Example) | <0.05 | 0.92 | Present disclosure |

(Y. Qin et al., Construction and Building Materials, vol. 215, pp. 114-118, 2019), (M. Shimogori et al., Solar Energy Materials and Solar Cells, vol. 201, p. 110088, 2019), (A. Palacios et al., Solar Energy Materials and Solar Cells, vol. 201, p. 110088, 2019), (V. Strapolova et al., Journal of Spacecraft and Rockets, vol. 55, no. 1, pp. 49-53, 2018), (Engineering ToolBox. “Absorbed Solar Radiation.” The Engineering ToolBox. https://www.engineeringtoolbox.com/solar-radiation-absorbed-material s-d_1568.html (accessed Feb. 11, 2021)), (J. Henninger, “Solar Absorptance and Thermal Emittance of Some Common Spacecraft Thermal-Control Coatings,” Goddard Space Flight Center, Greenbelt, Md., 1984), (N. Siegel et al., Energy Procedia, vol. 49, pp. 1015-1023, 2014)

### Example 4: Durability and Recoverability

Concentrating solar power highly recommends the operating temperature at or above 1000° C. due to energy efficiency. The particles of the present disclosure show durability at an ultra-high temperature. For example, the particles are not agglomerated and aggregated after exposing at 1,000° C. in air for 2 days. It is significant to determine the absorption change after exposing the particles at ultra-high temperatures. The measured absorptivity can be converted to the sunlight-absorbed value in percent demonstrating the overall absorption in 280 nm-2500 nm wavelength. The sunlight-absorbed percent (E) is calculated using Equation 4 below.

$$E = \frac{{\int }_{{λ}_{min}}^{{λ}_{max}} I ( λ ) \cdot A ( λ ) d λ}{{\int }_{{λ}_{min}}^{{λ}_{max}} I ( λ )} \qquad Equation 4$$

where I(λ) is the spectral distribution of the solar incident irradiance considered within the wavelength range (λmᵢₙ, λₘₐₓ), and A(λ) is absorption.

The present disclosure shows 92% of sunlight absorption (FIG. 7). Even though the absorption is dropped to only 74% after exposure at 1,000° C. in air for 2 days (FIG. 9), the exposed particles recover the sunlight absorptivity by reducing the particles at 300° C.-900° C. The recovery process performs from 3 hours to 24 hours. The sunlight-absorbed percent is recovered by increasing the reduction process (FIG. 9). The 3-hour reduction recovers the absorptivity by 85%. The 14-hour and 24-hour show 89%. Thus, the 14-hour reduction time is recommended for recovery process.

The fabrication was in two steps: (1) mixing for hematite coating and (2) sintering the hematite-sand at 400° C. in forming gas (5% H₂) for 3 hours. AMS fabricated 22 batches; each batch contained 500 grams of hematite-sand particles. The fabricated batches were characterized by UV-Vis-NIR with an integrated sphere for measuring solar absorptivity. The measured absorptivity was used for calculating the sunlight-absorbed fraction (E). The equation is as follows (Gimeno-Furio, A. et al., Renew. Energy 2020, 152, 1-8. https://doi.org/10.1016/j.renene.2020.01.053.):

$$E = \frac{{\int }_{{λ}_{min}}^{{λ}_{max}} I ( λ ) \cdot A ( λ ) d λ}{{\int }_{{λ}_{min}}^{{λ}_{max}} I ( λ )} .$$

where

$$\sqrt{I ( λ )}$$

is the spectral distribution of the solar incident irradiance considered within the wavelength range

$$\sqrt{( {λ}_{min} , {λ}_{max} )} , and \sqrt{A ( λ )}$$

is the absorption spectra. Calculations were completed according to Eq. (6), by using the CIE solar spectrum with an air mass m=1.5 for the solar incident irradiance (Standard Tables for Reference Solar Spectral Irradiances: Direct Normal and Hemispherical on 37° Tilted Surface https://www.astm.org/g0173-03r20.html) and considering the corresponding integration bounds for each wavelength range.

The fraction was converted to a percentage. The collected data was analyzed by six sigma with 11 subgroups or a subgroup size of 2. The Xbar chart monitoring the mean for process stability over time showed that the absorptivity points were aligned around the center line

$$\sqrt{( {x}^{\overline{\_}} = 91.837 )}$$

and within the control limits (+/−1.07% from the mean value

$$\sqrt{( {x}^{\overline{\_}} )} ) .$$

The R chart monitoring the variation for process stability over time also showed that absorptivity points were aligned near the center of the line

$$\sqrt{( \overline{R} = 0.525 )}$$

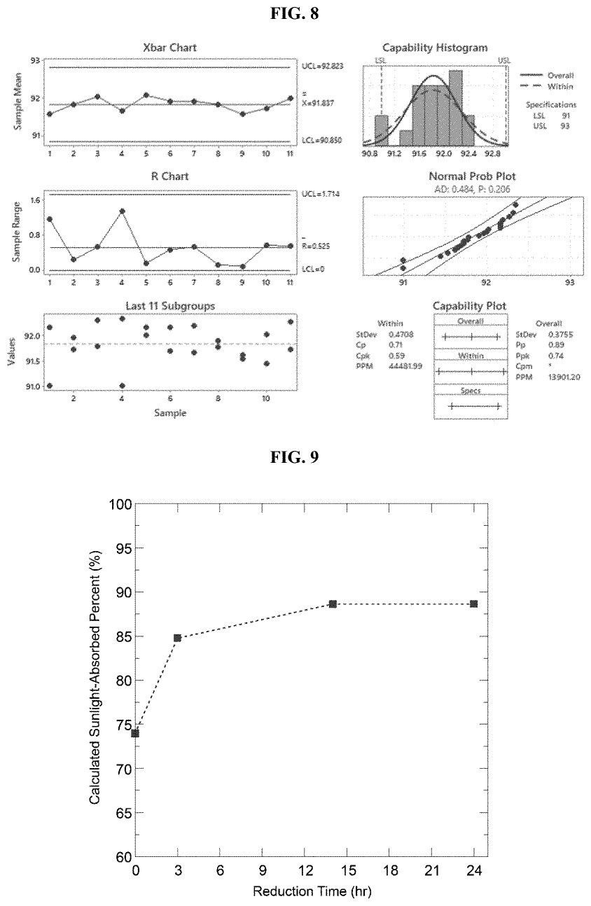

within the upper and lower control limits. The capability histogram showed the distribution of the sample data. The lower (LSL) and upper limits (USL) were set up to a 1% difference from the average value from the previous results (92%). Even though the dashed curve was not perfectly aligned with the solid curve due to two data points on the LSL, the rest of the data points were within the LSL-USL range with a low standard deviation (0.47). Overall, the particle fabrication developed by AMS reproduced the consistent absorptivity. In this task, as shown in FIG. 8, AMS resolved the technical issue of solar absorptivity and demonstrated reproducibility of the absorptivity as high as 0.92 in the mean value.

### Example 5: Multiple Recoverability

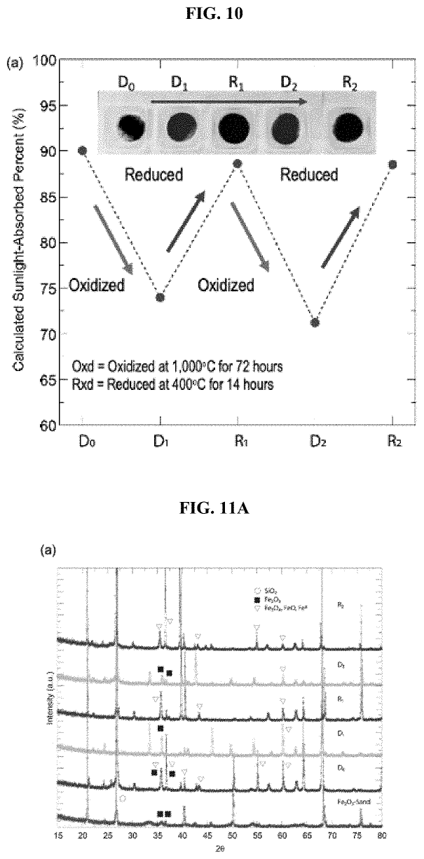

When the spent particles after exposing in the concentrated sunlight are recovered multiple times, the overall operation and maintenance costs are significantly reduced in long-term. The particles of the present disclosure are exposed in air at 1,000° C. for 2 days. Then, the exposed particles are recovered by reducing them at 300° C.-900° C. These processes are repeated to identify multiple recoverability. The absorption of the particles is measured from 280 nm to 2500 nm. The measured absorption is converted to the sunlight-absorbed percent as described in Equation 4. The freshly fabricated particles show over 90% of sunlight absorption. The first exposure demonstrates 16% of the absorption drop. However, the dropped absorption is recovered back to 89%. The second exposure drops the absorption to 73%, but the second recovery successfully increases the absorption to 89% (FIG. 10).

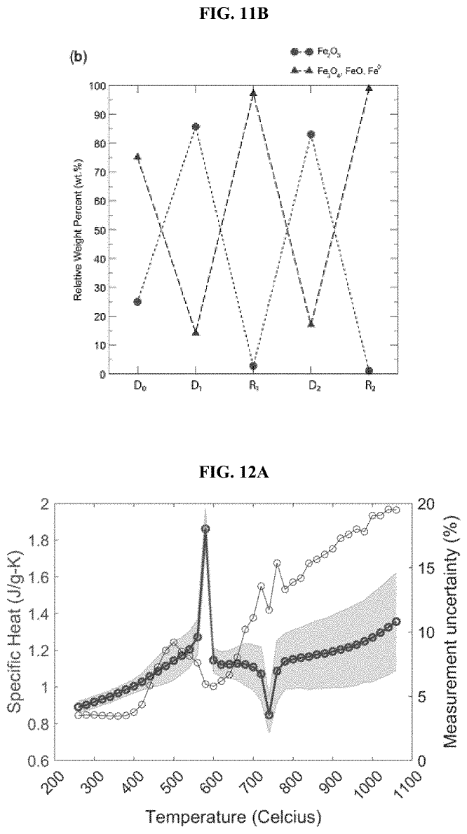

FIG. 11B shows the XRD raw data by refined to quantify the iron oxides in weight percent. The COD database was used for refinement. Initially, AMS4003 (D₀) dominant iron oxide was Fe₃O₄, FeO and Fe. However, Fe₂O₃ became a significant AMS4003 (D₁ and D₂) structure after exposure to air at 1,000° C. for 72 hours. The hematite weight percent decreased by reducing the spent AMS4003 particles (R₁ and R₂).

In short, AMS demonstrated that the oxidized or spent particles recovered solar absorptivity as high as the initial value (0.9). The recoverability was performed multiple times. The multiple recoverability can produce consistent energy generation because solar absorptivity will retain high value. Other benefits are an extension of a lifetime and a significant reduction of maintenance costs in the long term. The proof of recovery will highly impact the Levelized cost of energy (LCOE) long-term.

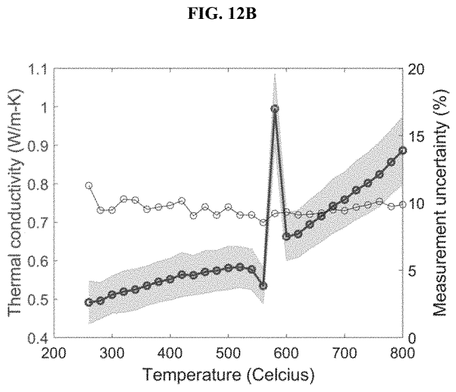

FIG. 12A shows specific heat of the particle from 250° C. to 1050° C. The specific heat demonstrated the amount of heat added to one unit of mass of the particles to cause an increase of one unit in temperature. The specific heat started 850 J/(Kg·K) at 250° C. and increased to 1250 J/(Kg·K) at 800° C. The results showed that the phase change in near 580° C., and the second phase change at 740° C.

FIG. 12B shows the thermal conductivity of the particle. Thermal conductivity is one of the essential thermal properties for thermal media as storage purpose. The higher the thermal conductivity of the particles, the faster will be the rate of heat loading or releasing from the thermal energy storage (TES) system. The result showed the thermal conductivity was 0.5-0.88 W/(m·K).

Although specific configurations of the present disclosure have been described in detail, those skilled in the art will appreciate that this description is provided to set forth preferred embodiments for illustrative purposes and should not be construed as limiting the scope of the present disclosure. Therefore, the substantial scope of the present disclosure is defined by the accompanying claims and equivalents thereto.

1. A particle for heat transfer or heat storage comprising:
(a) a core comprising silica; and
(b) a metal oxide coating layer coated on the core.

2. The particle for heat transfer or heat storage of claim 1, the silica is silica sand.

3. The particle for heat transfer or heat storage of claim 1, wherein the metal oxide is at least one selected from the group consisting of hematite (Fe₂O₃), magnetite (Fe₃O₄), ferrous oxide (FeO) and zero-valent iron (Fe⁰).

4. The particle for heat transfer or heat storage of claim 1, wherein the metal oxide is 5 to 10 parts by weight based on 100 parts by weight of the silica.

5. The particle for heat transfer or heat storage of claim 1, wherein the particle size of the particle for heat transfer or heat storage is 100 μm to 800 μm.

6. The particle for heat transfer or heat storage of claim 1, wherein the roundness and sphericity of the particle for heat transfer or heat storage are 0.8 or greater and 0.8 or greater, respectively.

7. The particle for heat transfer or heat storage of claim 1, wherein the particle for heat transfer or heat storage is used as heat transfer or storage media in concentrating solar power systems.

8. A method of producing the particle for heat transfer or heat storage of claim 1, comprising:
(a) mixing silica, water, and metal oxide powder to obtain a slurry;
(b) milling the slurry, and
(c) sintering the milled slurry.

9. The method of producing the particle for heat transfer or heat storage of claim 8, wherein the milling is performed at room temperature.

10. The method of producing the particle for heat transfer or heat storage of claim 8, wherein the sintering is performed under gas atmosphere of hydrogen gas balancing argon gas or nitrogen gas.
